(19) United States
(12) Patent Application Publication
(10) Pub. No.: US 2017/0046620 A1
(43) Pub. Date: Feb. 16, 2017

(54) Method and Apparatus for Decision Support

(71) Applicant: Hill-Rom Services, Inc., Batesville, IN (US)

(72) Inventor: William A. Morrison, Batesville, IN (US)

(21) Appl. No.: 14/848,742

(22) Filed: Sep. 9, 2015

Related U.S. Application Data
(60) Provisional application No. 62/203,520, filed on Aug. 11, 2015.

(51) Int. Cl. G06N 5/04; A61G 7/015; G06F 19/00; A61G 7/018

(52) U.S. Cl. CPC G06N 5/045; A61G 7/018; A61G 7/015; G06F 19/345; A61G 2203/20; A61G 2203/30

(57) ABSTRACT

A method of providing decision support in connection with a care recipient and a suite of care delivery devices which includes at least one adjustable system includes the steps of 1) receiving a command to effect a change to a parameter of the adjustable system, 2) assessing whether or not carrying out the command will result in one or more ramifications, and 3) if a ramification is identified, a) issuing a report related to the identified ramification, and b) complying with the command only if a confirmation is received subsequent to the assessing step.

### TECHNICAL FIELD

The subject matter described herein relates to a method of decision support, and is described in the context of decision support related to a care recipient in a clinical environment.

### BACKGROUND

Caregivers in hospitals and other health care environments regularly make decisions concerning the care administered to their patients. In modern caregiving facilities the caregiver may have access to numerous resources and large volumes of data. The availability of the resources and data are beneficial, however a caregiver can at times be overloaded with more information than she can effectively evaluate during the time available for her evaluation. As a result, a caregiver might benefit from devices and techniques that provide information about possible undesirable consequences of a care decision before that decision is carried out and, if possible, that recommend an alternative.

### SUMMARY

This application discloses a method of providing decision support in connection with a care recipient and a suite of care delivery devices. The suite of devices includes at least one adjustable system. The method includes the steps of 1) receiving a command to effect a change to a parameter of the adjustable system, 2) assessing whether or not carrying out the command will result in one or more ramifications, and 3) if a ramification is identified, a) issuing a report related to the identified ramification, and b) complying with the command only if a confirmation is received subsequent to the assessing step.

### BRIEF DESCRIPTION OF THE DRAWINGS

The foregoing and other features and variants of the method of decision support described herein will become more apparent from the following detailed description and the accompanying drawings in which:

FIG. 1 is a schematic view of a suite of care delivery devices for delivering care to a care recipient. The illustrated suite of devices includes a bed, shown in a left side elevation view, having an elevatable frame shown in a horizontal orientation and a multi-sectioned deck shown with a flat profile.

FIG. 2 is a view similar to FIG. 1 with the elevatable frame shown at a head down orientation

FIG. 3 is a view similar to FIG. 1 with selected deck sections shown at orientations such that the deck has a contoured profile.

FIG. 4 is a schematic perspective view of a mattress of FIGS. 1-3.

FIG. 5 is a cross section taken in the direction 5-5 of FIG. 4.

FIG. 6. is a graph explaining parameters of a CLRT function.

FIG. 7 is an architectural schematic showing selected elements of FIGS. 1-3 and also showing a controller and an information repository or record.

FIG. 8 is a flow diagram of a method of decision support which assesses whether or not carrying out a command will result in one or more ramifications and, if so, requires a confirmation before carrying out the command.

FIG. 9 is a view of a user interface, including an information display, used in the method of FIG. 8.

FIG. 10 is a flow diagram showing a variant of the method of FIG. 8 in which a confirmation is unconditionally required.

FIG. 11 is a flow diagram similar to that of FIG. 8 showing a variant in which a report of the ramifications includes suggestions of alternate commands.

FIG. 12 is a view of a user interface, including an information display, used in the method of FIG. 11.

FIG. 13. is a chart presented in the context of FIGS. 11-12 and summarizing user actions and associated responses of the method of decision support disclosed herein.

FIG. 14 is a block diagram similar to that of FIGS. 8 and 11 showing a variant of the method which includes a step of information acquisition.

FIGS. 15, 16, 17 and 18 are views similar to those of FIGS. 1 and 7-9 respectively giving a specific example of the method of decision support disclosed herein.

FIG. 19 is a view similar to that of FIG. 18 which presents another specific example when viewed in conjunction with FIGS. 15-17.

FIG. 20 is a view similar to that of FIG. 18 which presents another specific example when viewed in conjunction with FIGS. 15-17.

FIGS. 21 and 22 are block diagrams showing two slightly different enhancements to the variant of the method shown in FIG. 17 in which the method makes updated assessments based on newly acquired information.

FIGS. 23-24 are a portion of the block diagram of FIG. 21 or 22 and an architectural schematic providing an example and a further elaboration of the method of either of FIGS. 21 and 22.

FIG. 25 is a portion of the block diagram of FIG. 21 or 22 showing an enhancement in which the method uses an evaluation of the care recipient's response to amend an algorithm originally used to carry out the assessment step.

### DETAILED DESCRIPTION

This application discloses methods and devices that provide decision support in connection with a care recipient, for example a hospital patient, and a suite of care delivery devices. The suite of devices includes at least one adjustable system that has settings or parameters that a user can routinely adjust. A caregiver, such as a nurse, issues a command to adjust one of the adjustable settings. An assessment is carried out to predict whether or not carrying out the command will result in a ramification, which is an unsatisfactory consequence of carrying out the command. Unsatisfactory consequences include consequences that are detrimental to the patient and consequences that may provide less benefit than is normally expected. If a ramification is identified, the method issues a report related to the identified ramification and complies with the command only if the caregiver provides a confirmation that she wishes to proceed with the command. In one embodiment the caregiver uses a user interface such as a keypad or touchscreen to issue the command, and the assessment is carried out by a processor which executes an algorithm.

By way of example, a hospital patient is supported on a mattress of a hospital bed, the mattress being a care delivery device administering continuous lateral rotation therapy to the patient. The bed frame includes a touchscreen to receive and convey commands from the caregiver to the mattress and to display messages. In this example, a processor is interposed between the touchscreen and the mattress, and the processor is additionally electronically coupled to a memory storing the patient's electronic medical record (“EMR”).

In this example, the caregiver utilizes the touchscreen to issue a command to increase the angle achieved by the patient during the continuous lateral rotation therapy. However, information stored in the EMR indicates that the patient has a weakened right lung. Based on the nature of the command and the information in the EMR, the processor assesses that the command issued by the caregiver could cause additional stress on the patient's right lung, and before implementing the caregiver's command, causes the touchscreen to display a warning. The caregiver may choose to cancel his command, or may, instead, choose to execute his command by indicating, through the touchscreen, his confirmation that the command is to be carried out. If the caregiver neither cancels nor confirms his command, the processor may be configured to wait for the termination of a pre-established period of time, and then either automatically cancel the command or to automatically execute the command.

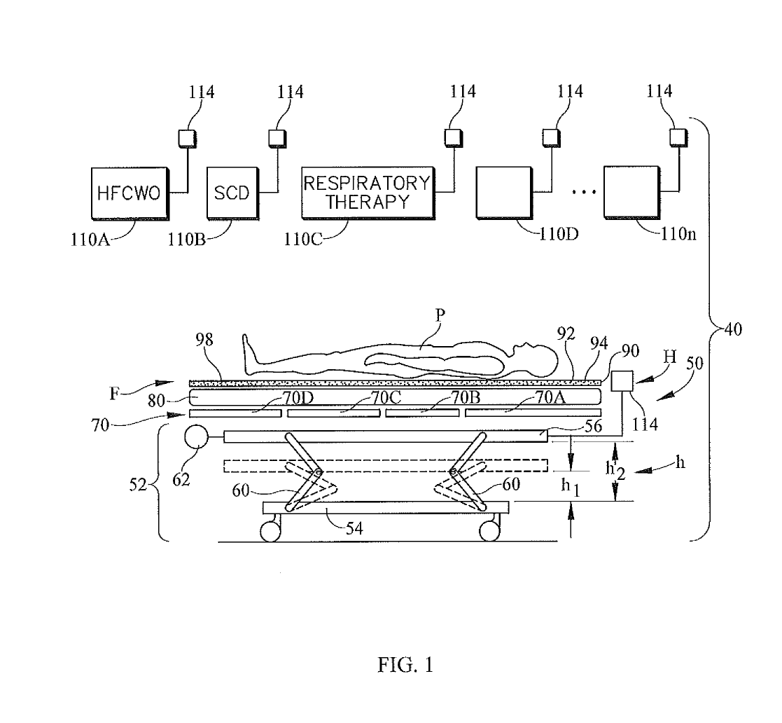

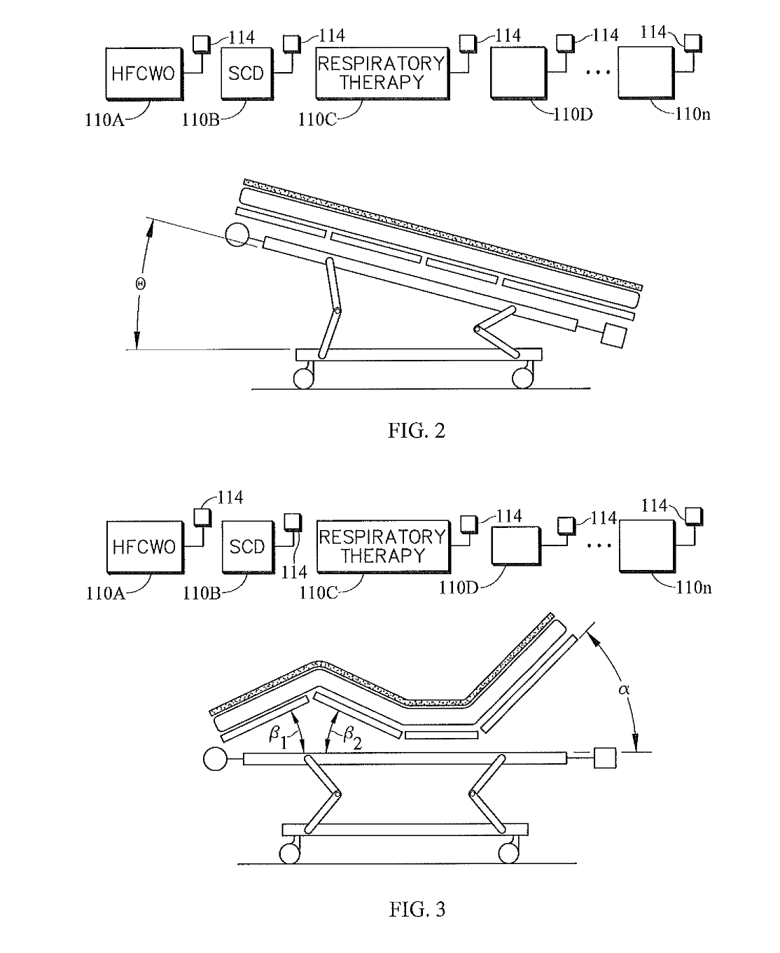

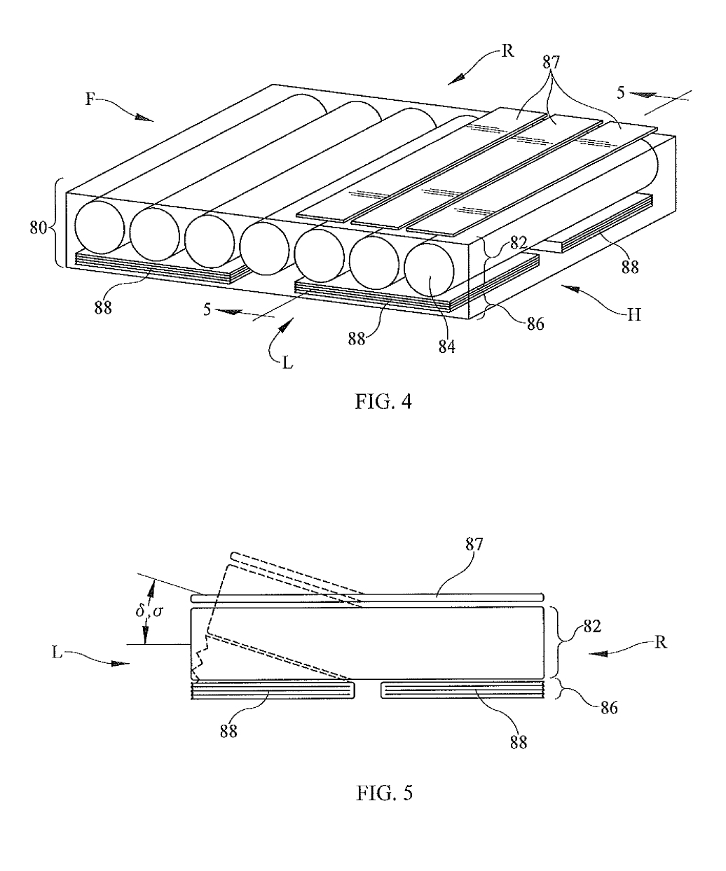

Referring to FIGS. 1-5 a suite of care delivery devices 40 for delivering care to a care recipient P includes a bed 50 extending longitudinally from a head end H to a foot end F and laterally from a left side L to a right side R (seen in FIGS. 4-5). The bed includes a framework 52 comprised of a base frame 54 and an elevatable frame 56 supported on the base frame by supports 60. Frame actuators, not illustrated, are provided to change various adjustable parameters of the elevatable frame. One example of an adjustable parameter is the elevation or height h of the elevatable frame relative to the base frame, which can be adjusted between h₁ and h₂. Another example is the inclination angle θ of the elevatable frame, which can be adjusted so that the elevatable frame is in a head down orientation (FIG. 2) or a foot down orientation (not illustrated). An air pump 62 is attached to the framework.

The bed framework also includes a deck 70 supported on the elevatable frame. The illustrated deck includes an upper body or torso section 70A corresponding approximately to the head and torso of a bed occupant, a seat section 70B corresponding approximately to the occupant's buttocks, a thigh section 70C corresponding approximately to the occupant's thighs, and a calf section 70D corresponding approximately to the occupant's calves and feet. Deck actuators, not illustrated, are provided to change the profile of the deck between a flat profile (FIGS. 1-2) and a contoured profile (FIG. 3) by changing one or more of orientation angle α of the torso section, orientation angle β₁ of the calf section, and orientation angle β₂ of the thigh section. Accordingly, adjustable parameters of the deck include angles α, β₁ and β₂.

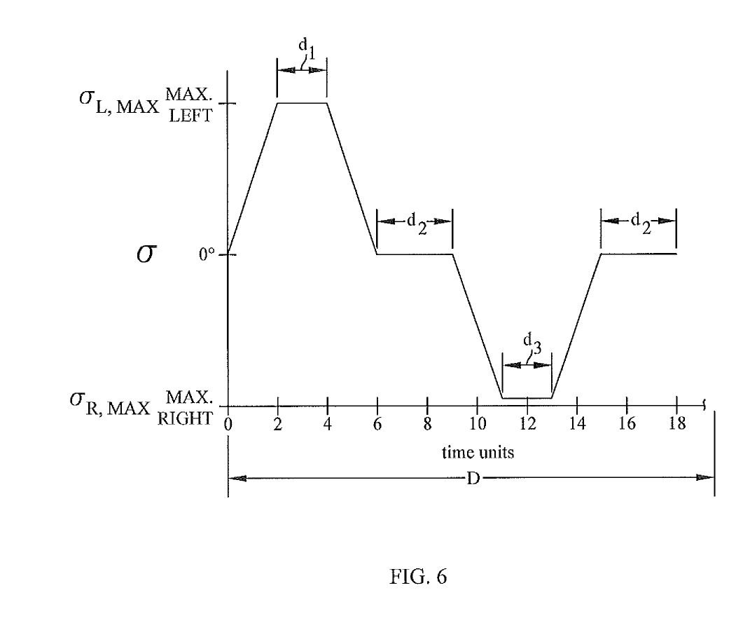

The illustrated bed also includes a mattress 80 supported on the deck. The illustrated mattress is another member of the device suite. The mattress includes an occupant support layer 82 comprised of an array of laterally extending, longitudinally distributed occupant support bladders 84 which can be pressurized to a desired pressure with air from pump 62. One example of an adjustable parameter of the support bladders is the air pressure in the bladders. The mattress also includes a set of percussion and vibration (P&V) bladders 87. The P&V bladders can be provided with pulses of air (e.g. from from pump 62 or from a pump dedicated to the P&V bladders). The air pulses apply a percussion and vibration (P&V) pulmonary therapy to the occupant. Adjustable parameters of the P&V mode of operation include the percussive frequency and intensity (pressure amplitude) of the air pulses. The illustrated mattress also includes a turn layer 86 comprised of a set of turn bladders 88. As seen in FIG. 5 the turn bladders on one or the other of the lateral sides of the bed can be inflated to and held at a nonzero angle δ in order to orient support layer 82 at substantially the same angle δ. This may be useful to assist a caregiver in turning a patient from supine to prone or vice versa, or to allow a caregiver easier access to portions of the patient's body that face the support layer. The turn bladders can also be repetitively inflated and deflated out of phase with each other to apply pulmonary therapy by gently turning the bed occupant left and right. This process is referred to as Continuous Lateral Rotation Therapy (CLRT). When the turn bladders are used in the CLRT mode the turn angle is designated σ to distinguish it from the steady state angle δ. Referring additionally to FIG. 6, the adjustable parameters of CLRT include maximum turn angles σ_{L,MAX}, σ_{R,MAX}. The maximum turn angles need not be equal to each other, and one of them can be zero. The CLRT adjustable parameters also include dwell times d₁, d₂, d₃, which are time intervals during which a remains constant. One or more of the dwell times may be zero. The CLRT adjustable parameters also include the period T or frequency f. FIG. 6 shows a CLRT cycle having a period T of 18 time units or, equivalently, a frequency f of one cycle per 18 time units. The cycle period is, of course, dependent on the dwell times and the rate of change of turn angle σ with respect to time, dσ/dt. These rates may be adjustable either independently or nonindependently. The adjustable CLRT parameters also include total duration D of the CLRT therapy.

The illustrated bed also includes a topper 90, which is also a member 40 of the device suite. The illustrated topper is a microclimate management topper. A typical microclimate management topper includes a vapor permeable fabric or fabric-like cover or ticking 92 which bounds an interior volume 94. A spacer material 98 resides in the interior volume. During use of such a topper, a stream of air flows through the interior of the topper from the foot end of the topper to the head end of the topper and is then vented to atmosphere. Prior to being supplied to the topper the air may be heated or cooled to regulate temperature in the immediate vicinity of the occupant. In addition, when an occupant of the bed perspires on the topper the perspiration, which is mostly water, vaporizes and passes across the vapor permeable cover or ticking and into the airstream. The airstream carries the perspiration vapor (i.e. water vapor) out of the interior of the topper. As a result the topper counteracts any tendency for moisture to accumulate on the occupant's skin thereby further enhancing occupant comfort and reducing the likelihood that the occupant will develop pressure ulcers. Typical adjustable parameters of the microclimate M management topper include air temperature and flow rate of air through the topper.

The illustrated suite of devices 40 also includes a set of several stand-alone devices designated generically as 110 and individually as 110 plus a letter suffix. One member of the set of stand alone devices is a high frequency chest wall oscillator (HFCWO) 110A. A HFCWO may be in the form of a garment which a care recipient wears. The garment includes air bladders adjacent the care recipient's lungs. In operation the HFCWO device is supplied with pulses of compressed air in order to apply percussive therapy to the wearer's chest thereby loosening lung secretions. Examples of the adjustable parameters of an HFCWO device include the frequency and intensity of the air pulses and the duration of time over which the therapy is applied.

The illustrated device suite also includes a sequential compression device (SCD) 110B which may be integrated with the bed or may be a separate device. One example of a compression device is a pressurizable sleeve that circumscribes a care recipient's calf. In operation the pressurized air is repetitively supplied to and exhausted from the sleeve thereby cyclically squeezing the calf in order to combat deep vein thrombosis. Examples of adjustable parameters of an SCD device include the maximum pressurization of the sleeve, squeeze frequency, and duration of the sequential compression therapy.

The illustrated device suite also includes an oral delivery respiratory therapy unit 110C. One example of an oral delivery respiratory therapy unit is an aerosol generator which delivers a medicated aerosol orally to the care recipient who can then inhale the medication. Another example is a continuous high frequency oscillation (CHFO) therapy device which delivers pulses of air orally to the care recipient to treat respiratory problems. Another example is a continuous positive expiratory pressure (CPEP) therapy device. Other respiratory therapy units are composite or hybrid devices capable of delivering two or more types of respiratory therapy individually or in combination when appropriate (e.g. CHFO and medicated aerosol) depending on an operational mode selected by a user. Typical adjustable parameters include the mode of operation of a composite device and the frequency of CHFO.

The device suite may have members 40 other than the bed framework, mattress, topper, HFCWO device, SCD device and respiratory therapy device enumerated above. In addition, sub-elements of a member of the device suite can themselves be considered to be members of the device suite instead of or in addition to the parent device. For example support bladders 84, P&V bladders 87, and turn bladders 88 of mattress 80 can be considered to be members of the device suite.

In FIGS. 1-5 the HFCWO, SCD and respiratory therapy devices are illustrated as stand-alone devices, i.e. devices not integrated with bed 50. By contrast, mattress 80 and topper 90 are illustrated in a way suggestive of being integrated with bed framework 52. However the principles described herein apply irrespective of whether or not a member of the device suite is integrated with one or more other members of the device suite. At least in principle, devices shown or described as stand-alone can be integrated with other devices, and devices shown or described as integrated could be configured as stand-alone devices.

The bed framework, mattress, topper, HFCWO device, SCD device and respiratory therapy devices described above are examples of adjustable systems of the suite of care delivery devices or components that include adjustable systems. Thus, the suite of devices includes at least one adjustable system. As used herein, an adjustable system is one having an adjustable setting or parameter and which is configured so that a user can routinely adjust the setting, and therefore the device with which the setting or parameter is associated. Examples of adjustable parameters of the adjustable systems include those disclosed above.

The adjustable parameters of the adjustable systems can be classified as operational parameters or nonoperational parameters. An operational parameter is one that defines a characteristic of a repetitive or cyclical process. For example maximum turn angles ν_{L,MAX}, σ_{R,MAX}, dwell times d₁, d₂, d₃, period T or frequency f, and duration D of the CLRT process are operational parameters because they quantify the amplitude, dwell time, period or frequency, and duration of a CLRT process applied to a care recipient. A nonoperational parameter is one that does not define a characteristic of a repetitive process. For example deck angle α (FIG. 3) is a nonoperational parameter because it does not define a characteristic of a repetitive process. Similarly, turn bladder angle δ is a nonoperational parameter because inflating a turn bladder 88 to steady state turn angle δ to carry out a nonrepetitive rotation of a care recipient is not a repetitive process. The fact that a caregiver may rotate a patient from prone to supine at some later time does not cause δ to be an operational parameter. By contrast the turn angle σ of CLRT is an operational parameter because it defines a characteristic of an intentionally repetitive process.

Operational parameters and the associated adjustments can be classified as interventional or non-interventional. Interventional adjustments are those that affect a parameter or setting of a repetitive process while the process is already underway but not yet complete. (The adjustment can be thought of as intervening with or interrupting an ongoing repetitive or cyclical process in order to redefine a characteristic of that process, even if the process must be temporarily paused in order to make the adjustment.) Examples include changing a parameter setting of a repetitive process such as changing the frequency, dwell time, maximum inclination or total duration D of CLRT, changing the pulse frequency or intensity of HFCWO, and changing the mode of operation of a respiratory therapy unit or the adjustable parameters of one of its operational modes (e.g. frequency and intensity of CHFO) after the process has commenced but before the process has proceeded to completion. A non-interventional adjustment is one that does not affect an operational parameter of a repetitive process which was already underway but not yet complete at the time the adjustment is made. Examples of noninterventional adjustments and parameters include but are not limited to 1) changing the elevation h, inclination angle θ or profile angles α, β₁, β₂, of the bed frame (because no repetitive process is involved), 2) turning a function such as P&V, microclimate management or CLRT on or off (because even if the process is repetitive (such as P&V, CLRT) turning the process on or off does not affect a defining parameter of the process), 3) selecting the operational mode of a hybrid device such as the CHFO/CPEP device described above, and 4) setting or changing an operational parameter of a repetitive process while the process with which the parameter is connected is not yet underway. Because a user action does not have to affect a repetitive process which is already underway in order for that action to qualify as a change, the term “change”, as used herein in the context of an adjustable system, refers not only to making an interventional adjustment by changing the setting of an interventional parameter, but also to making a noninterventional adjustment by changing the setting of a noninterventional parameter (e.g. h, θ, α, β₁, β₂), turning a repetitive function ON or OFF, and setting a parameter of a repetitive function while the function is OFF.

The device suite also includes one or more user interfaces 114 which allow a user, such as the care recipient or a care provider, to interact with the devices of the device suite. A user interface is configured to receive commands from a user and/or to provide information to the user. Typical examples of a user interface include a keypad which allows a user to input commands, a display screen which provides status information to the user, and an interface unit having both a keyboard and a display. FIGS. 1-3 illustrate a one to one correspondence between devices 110A, 110B and 110C and their respective user interfaces 114. However other arrangements are possible. For example bed 50 typically may have two or more user M interfaces some of which are duplicates of each other, and others of which are unique. Some user interfaces are dedicated to a particular function or group of functions while others are dedicated to a different function or group of functions. Two distinct user interfaces may be designed to control or provide information about overlapping functions or groups of functions. For example a user interface might be associated with functions F1, F2 and F2 while a companion user interface might be associated with functions F2 and F4. A user interface need not be physically mounted on the device with which it is associated. For example the user interfaces for controlling and reporting information from mattress 80 and topper 90 may be mounted on the bed frame.

A user interface may be as simple as an ON/OFF switch. In other cases the interface may allow the user to select a mode of operation of the device, for example to select the CHFO or CPEP mode of a composite respiratory care unit. In yet another example the interface may allow the user to set the maximum turn angle σ, frequency f, dwell time d and total duration D of CLRT therapy.

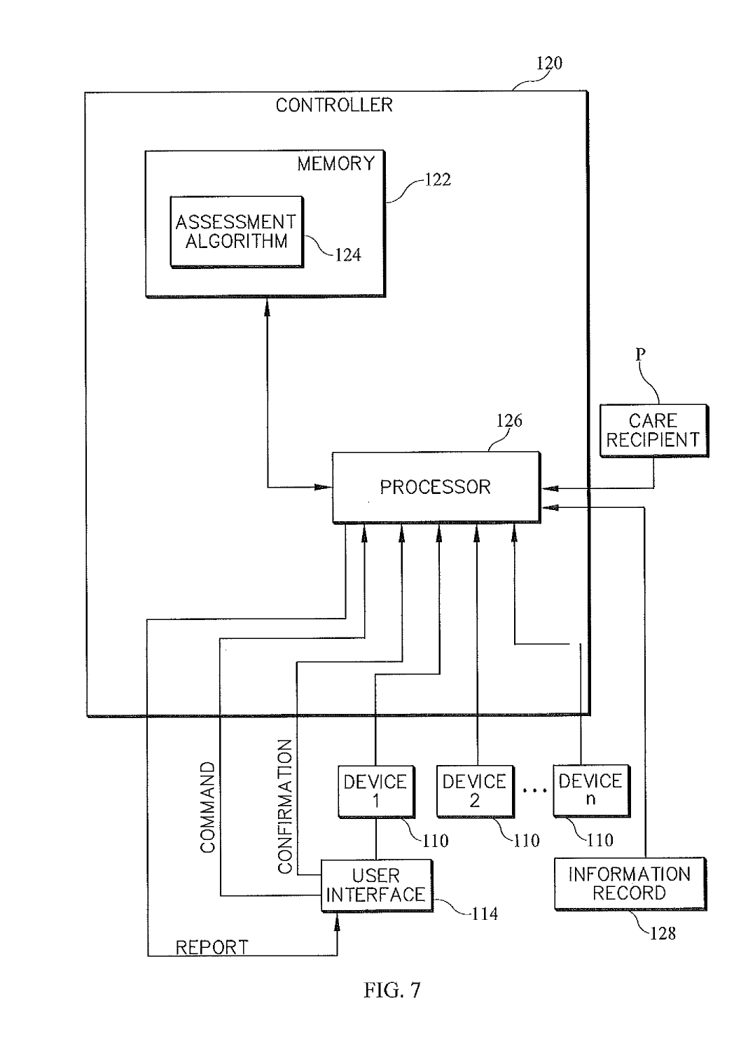

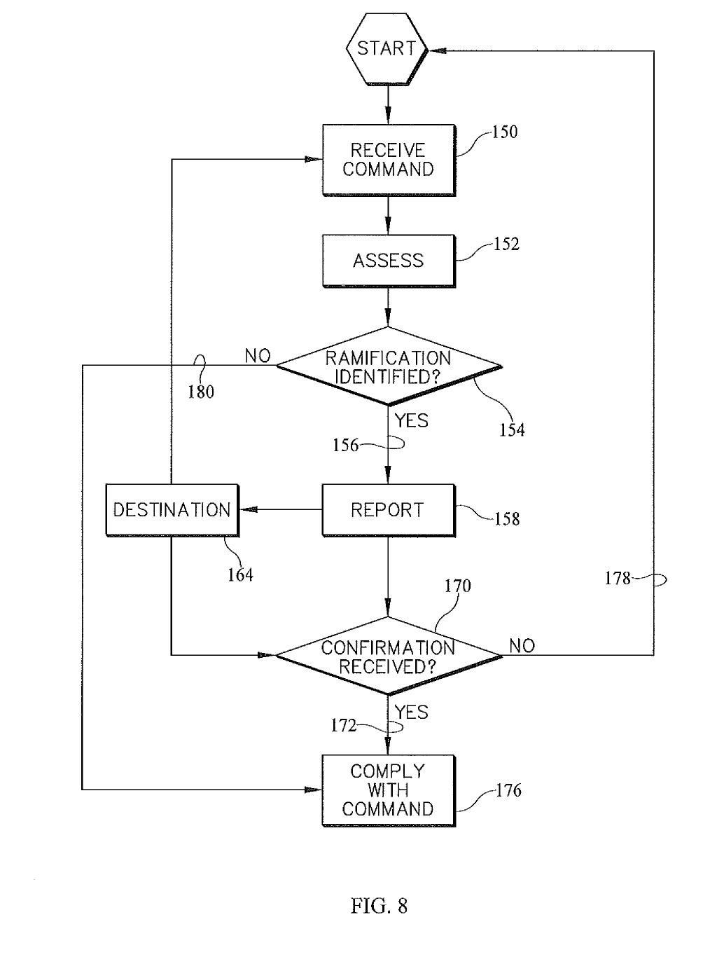

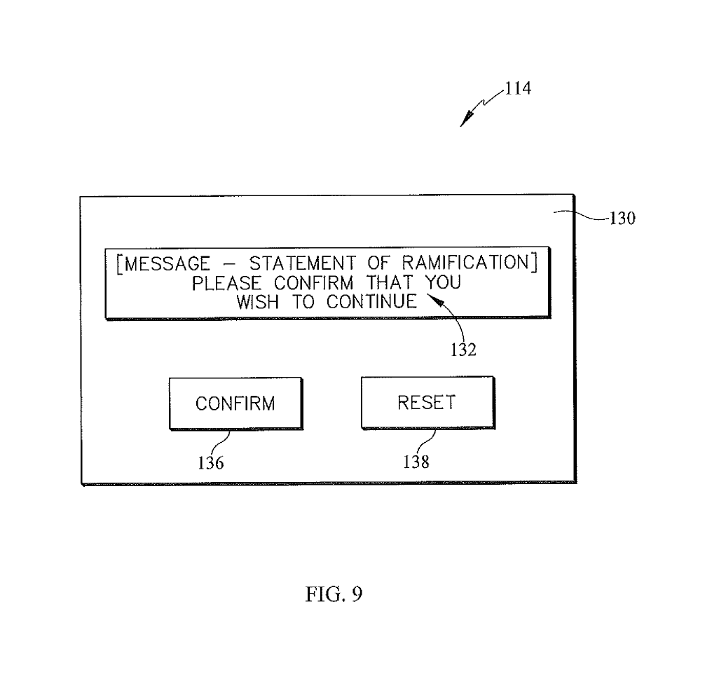

FIG. 7 is an architectural schematic showing selected elements of FIGS. 1-5 and also showing a controller 120 and an information repository or record 128 such as an electronic medical record (EMR). Only one user interface 114 is shown in FIG. 7 in order to preserve the clarity of the illustration. As illustrated, the controller includes a memory 122 which stores an assessment algorithm 124 and a processor 126 for executing the algorithm. Other computer architectures are, of course, possible. “Algorithm” as used in this specification means a set of instructions which accepts one or more inputs and operates on the inputs to produce an output. FIG. 8 is a flow chart showing a method of providing decision support in connection with a care recipient and a suite of care delivery devices which include at least one adjustable system. FIG. 9 is an example user interface for conveying information to a user and accepting a directive from the user. The user interface of FIG. 9 may be a stand alone interface or may be integrated into one of the other user interfaces of the device suite. The user interface includes a display area 130 in which a message 132 may be displayed to provide information to the user or to direct the user to take an action. The user interface also includes a CONFIRM key 136 and a RESET key 138.

At block 150 the method receives a user originated command to effect a change to one of the adjustable systems. In practice the command is provided through one of the user interfaces 114 and is conveyed to processor 126. At block 152 the method assesses whether or not carrying out the command will result in one or more ramifications. In practice, processor 126 executes algorithm 124 to assess whether or not carrying out the command will result in one or more ramifications. As used herein a “ramification” is an unsatisfactory consequence of carrying out the command or a consequence that is predicted to be less efficacious than would ordinarily be the case. Ramifications include consequences that are forecastable in the sense that they are subject to prediction based on real time, patient specific inputs from information sources which are extrinsic to the methodology of the algorithm. Examples of extrinsic information used in the course of making a prediction include information from a physiological sensor associated with the care recipient, information about the care recipient obtained from an information record, information imputable to a care recipient as a result of being a member of a particular class of individuals (e.g. the care recipient is classified as a “fall risk”), and information obtained from a member of the device suite. In addition, a lookup table that characterizes fall risk as a function of, for example, a care recipient's age and neurological condition), and which a programmer embeds in the algorithm, is nevertheless extrinsic information because 1) the table could have instead been stored external to the algorithm and 2) although the table affects the outcome of the prediction, its location (whether within the algorithm or in a portion of memory external to the algorithm) does not affect the methodology, which is to output a fall risk as a function of an age input irrespective of where the table happens to be stored. Ramifications also include cautionary advisories. Cautionary advisories are not based on patient specific inputs to the algorithm, although they may be based on experience and general knowledge. One example of a cautionary advisory is a reminder to a caregiver who has commanded an increase in elevation h of the elevatable frame 56 to be aware of the potential for the change in elevation to disturb intravenous (IV) lines and sensor lines. Another example of a cautionary advisory is a reminder to a caregiver who has requested a decrease in elevation of the elevatable frame to check for obstacles underneath the frame. Yet another example of a cautionary advisory is a message that higher values of CLRT angle can depress blood pressure and SpO₂.

If a ramification is identified, the method proceeds along YES branch 156 from block 154 and, at block 158, issues a report to a destination 164. The destination is a user interface, such as that of FIG. 9, capable of displaying that information in a user comprehensible form, e.g. in the form of a textual message. The content of the report, and of the message, is information related to the identified ramification and may or may not reveal the ramification itself. In FIG. 9 the message arising from the report includes a statement of the identified ramification and a request for the care provider to confirm that she wishes to proceed with her command as received at block 150.

At block 170 the method awaits confirmation that the user wishes to proceed with the command received at block 150. The confirmation may take the form of an explicit confirmation. An explicit confirmation is one that results from a definite action on the part of the user, for example pressing CONFIRM key 136. In one variant of the method the explicit confirmation is the only type of confirmation provided for. In another variant the confirmation may be an implicit confirmation. An implicit confirmation is one that results from something other than a definite action on the part of the user. One example of an implicit confirmation is the lapse of a time interval Δt_{COMPLY} after the conclusion of the reporting step 158 without the CONFIRM key having been pressed. In another variant the method recognizes both an implicit confirmation and an explicit confirmation, whichever occurs first. If the method receives an explicit or implicit confirmation at block 170 the method proceeds along YES branch 172 to block 176 and complies with the command received at block 150. If the method does not receive a confirmation at block 170 the method follows NO branch 178 and declines to comply with the command received at block 150. In a variant of the foregoing, the method may be set up so that if a time period Δt_{NO-COMPLY} passes without the user having pressed the CONFIRM key, the lack of user action is interpreted lack of confirmation, in which case the method follows path 178 from block 170. The choice of whether the passage of time is an implicit confirmation to comply with a received command (passage of time interval Δt_{COMPLY}) or a signal to not comply with the command (passage of time interval Δt_{NO-COMPLY}) is a mutually exclusive design choice.

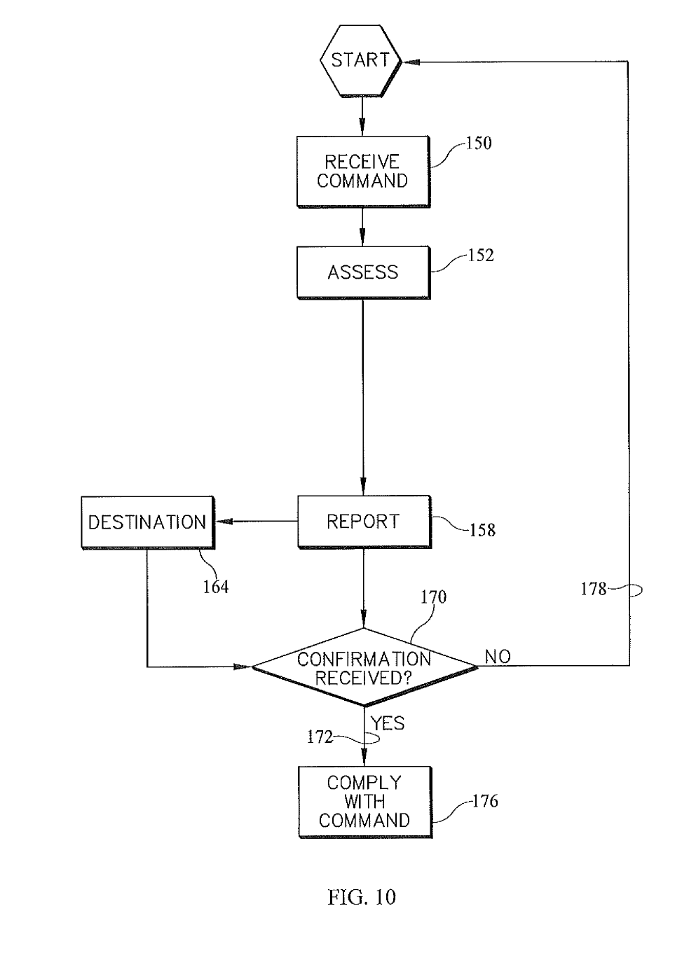

Returning now to block 154, if the method does not identify a ramification the method proceeds along NO branch 180 from block 154 to block 176 and complies with the command received at block 150 without further intervention on the part of the user. Alternatively the method could, even in the case of no ramification having been identified, require confirmation of the command. This modification is shown in the flow diagram of FIG. 10 where a report is issued at block 158 irrespective of whether or not a ramification had been identified. The user is then required to press the CONFIRM key to confirm acceptance of the command received at block 150, or to wait for the passage of time interval Δt_{COMPLY}.

The user may rescind the command entered at user interface 114 and received at block 150 by pressing RESET key 138. In practice the method monitors for a signal from RESET key for an indication of of the user's intent to rescind the command. If a command is rescinded the processor causes the method follows NO branch 178 from block 170 and declines to comply with the command received at block 150. If the method allows for an implicit confirmation in the form of a time lapse as described above (Δt_{COMPLY}) the user would have to press the RESET key before the expiration of the lapse time interval (Δt_{COMPLY}), otherwise the method will proceed along YES branch 172 from block 170.

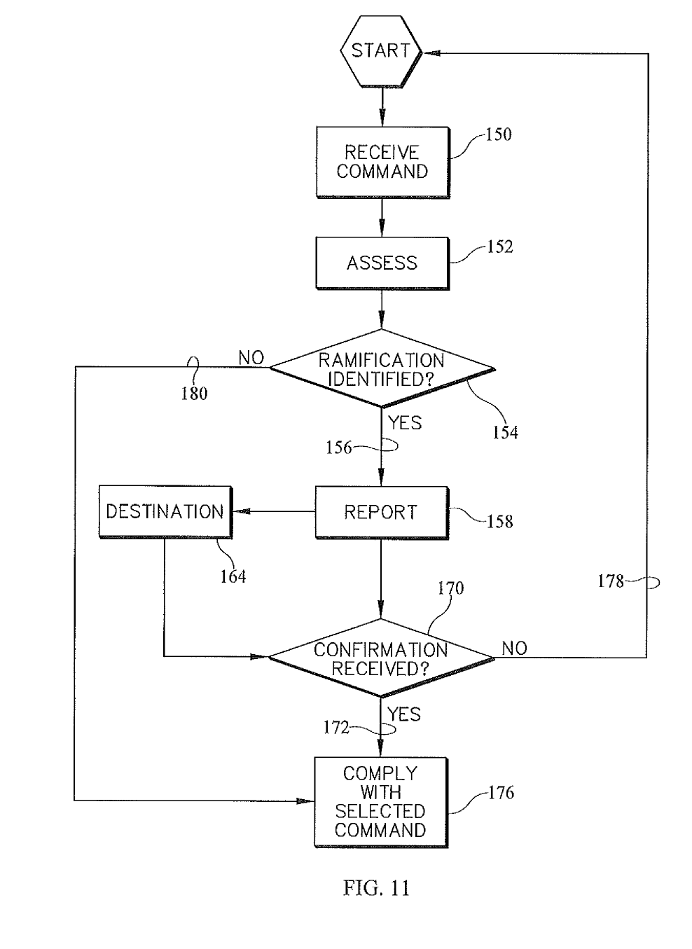

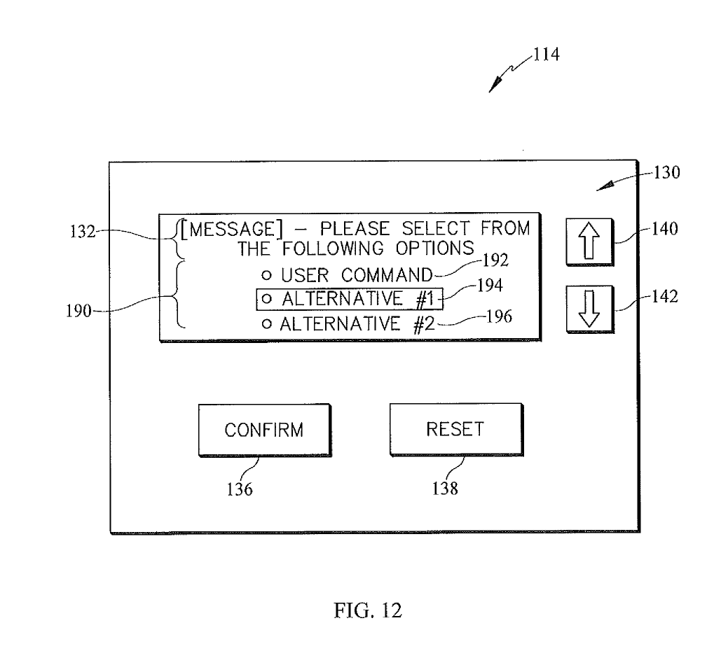

As described above the report issued at block 158 is a report having informational content related to the identified ramification. In FIG. 9 the messsage arising from the report is limited to the ramification itself and a request for further action. FIGS. 11-12 show a variant of the method in which the informational content of the report is still related to the identified ramification, but the message arising from the report also suggests at least one alternative to the command received at block 150. The diagram of FIG. 11 is the same as that of FIG. 8 except for the text label of block 176. The user interface of FIG. 12 is the same as that of FIG. 9, except that it includes a selector in the form of UP and DOWN arrow keys 140, 142. Moreover, display area 130 reveals not only the command received at block 150, but also at least one alternative to the command. The user can use arrow keys 140, 142 to select either the user command received at block 150 or one of the suggested alternatives.

As already described in connection with FIGS. 8-9, at block 150 the method of FIG. 11 receives a user originated command to effect a change to an adjustable parameter of one of the adjustable systems. In practice the command is provided through one of the user interfaces 114 and is conveyed to processor 126. At block 152 the method assesses whether or not carrying out the command will result in one or more ramifications. In practice processor 126 executes algorithm 124 to assess whether or not carrying out the command will result in one or more ramifications. If a ramification is identified, the method follows YES branch 156 to block 158 and reports not only the ramification but any alternative command that the algorithm identified. Alternatively the method could report only the alternative(s) without reporting the ramification.

If a ramification is identified, display area 130 displays the message 132 which, in FIG. 12, identifies the ramification and a menu 190 of options. Message 132 includes an instruction asking the user to select an option. The illustrated options include the command 192 originally received at block 150 and the alternative(s) 194, 196. The method may preselect one of the menu items (a default selection) in which case the default selection is visually distinguished on the display so that it stands out from the other options. In FIG. 1, alternate #1 is distinguished to demonstrate that it is the preselected option. Alternatively the method may instead be arranged to not select one of the menu items as a default in which case none of the menu items would be selected (and therefore none would be visually distinguished) until the user presses an UP or DOWN arrow.

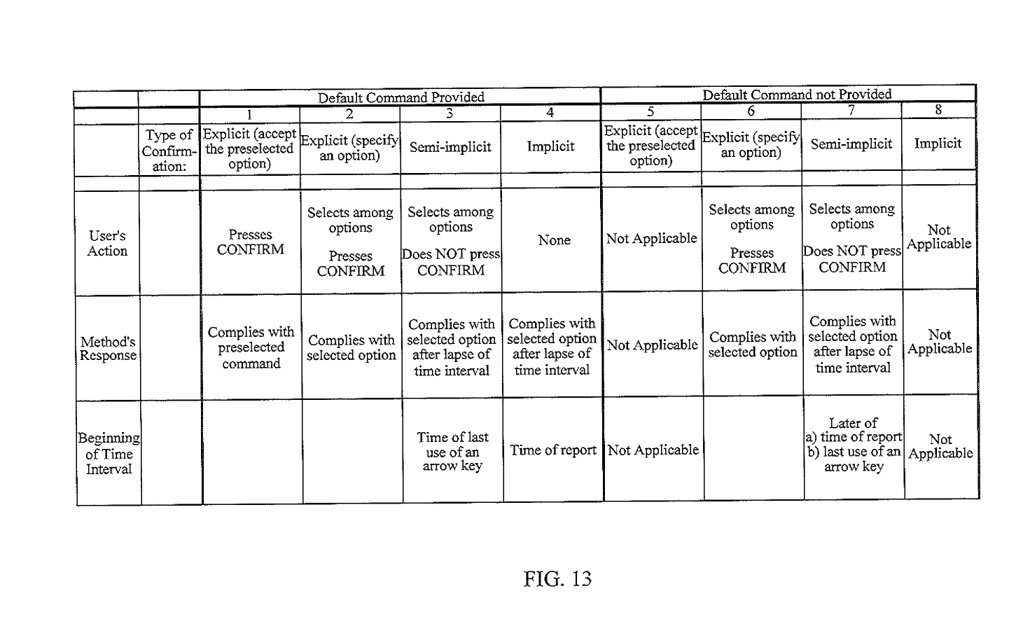

Referring additionally to FIG. 13, the method of FIGS. 11-12 may provide for a number of different user actions. Referring to column 1 of FIG. 13, if a default selection is provided, the method accepts an explicit confirmation to carry out the preslected default command by simply pressing the CONFIRM key. Because the user has two or more options to choose from, the confirmation can be considered to be a directive to carry out the selected command rather than a confirmation to carry out only one possible command as in FIG. 8. In the option of column 2 the user employs the UP and DOWN keys to move among the options thereby selecting one of them. The user then presses CONFIRM to issue an explicit confirmation of her intent for the selected option to be carried out. In the option of column 3 the method accepts a semi-implict confirmation. A semi-implicit confirmation is one in which the user uses the UP/DOWN keys to select an option but does not press CONFIRM. After the lapse of a time interval Δt_{COMPLY} the method complies with the command despite not having received an explicit confirmation. The time interval begins at the time the user last uses one of the UP/DOWN keys. In the option of column 4 the method accepts an implict confirmation. An implicit confirmation is one in which the user neither presses CONFIRM nor uses the arrow keys. After the lapse of a time interval Δt_{COMPLY} the method complies with the command. The time interval begins at the time the report is made at block 154.

In the case where there is no preselected default (columns 5-8), none of the options is visually distinguished at first, and therefore no option is considered to have been selected until the user uses the UP/DOWN keys to make a selection. Accordingly, columns 5 and 8, which mimic columns 1 and 4, are not applicable. The user actions provided for are those of columns 6-7 which are the same as those of columns 2 and 3 as already described.

Returning to FIGS. 11-12, At block 170 the method awaits confirmation that the user wishes to proceed with a selected command. If an expicit, semi-implicit or implicit confirmation is received at block 170 the method proceeds along YES branch 172 to block 176 and complies with the selected command. In this case the command complied with at block 176 is the command selected from menu 190 (i.e. the original command 192 received at block 150 if the user selects that command from menu 190 or a selected alternative command 194, 196 if the user selects an alternative from menu 190). If an implicit, semi-implicit or explicit confirmation is not received at block 170 the method follows NO branch 178 and declines to comply with the command received at block 150.

The user interface of FIG. 12 also includes a RESET key so that the user can rescind a command. If the user presses the RESET key the method follows NO branch 178 from block 170 and declines to comply with the command received at block 150. If the method allows for an implicit confirmation in the form of a time lapse as described above the user would have to press the RESET key before the expiration of the lapse time interval, otherwise the method will proceed along YES branch 172 from block 170.

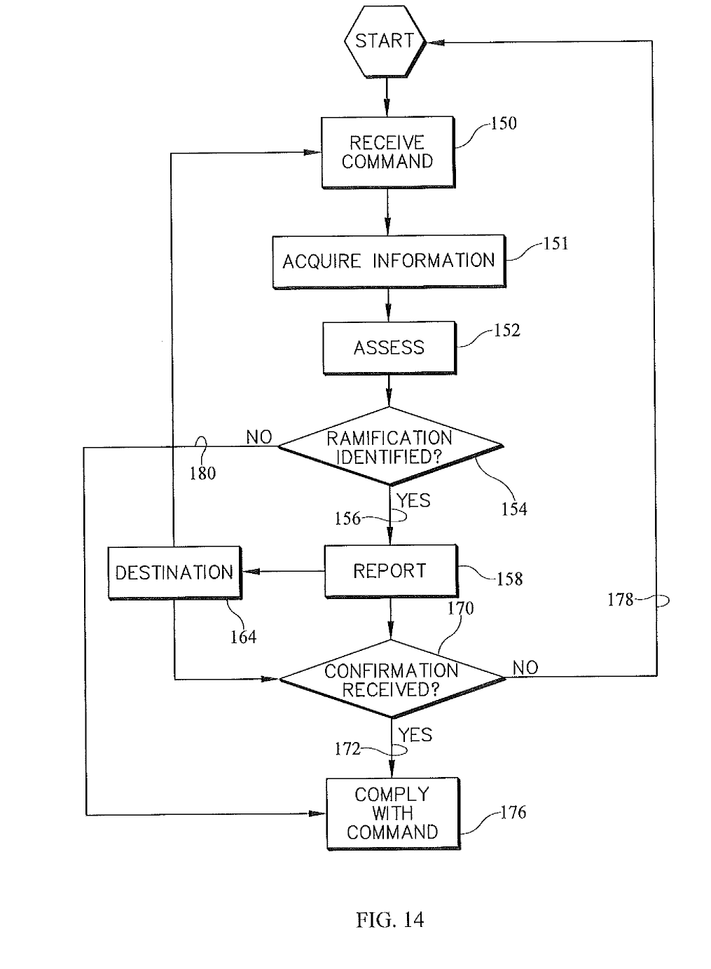

FIG. 14 shows a variant of the method in which assessing step 152 relies on information from relevant sources to make the assessment. Referring additionally to FIG. 14 and also to FIGS. 1 and 7, the method acquires that information at step 151. The information acquisition can be an on-demand acquisition initiated by the algorithm, or it can be a periodic data feed or a substantially continuous data feed from the sources of the information. The step of acquiring information is illustrated between steps 150 and 152 of FIG. 14 but can be placed anywhere in the sequence of actions that would make the information available in time for assessment step 152 to use it. The information sources include one or more of a) the care recipient P, b) an information record 128, and c) a member 40 of the device suite. Information acquired from the care recipient includes real-time information from, for example, a sensor associated with the care recipient. Such sensors may be attached to the care recipient or may be in the vicinity of the care recipient but nevertheless associated with the care recipient. Specific examples include SpO2 sensors and heart parameter sensors which collect information about the care recipient's physiological state. Information acquired from the care recipient may also include remarks from the care recipient and observations of the care recipient made by the caregiver. Information records include databases such as electronic medical records (EMR's) which may contain information specific to the care recipient such as past readings of physiological parameters, and information such as classification of the recipient as a person known or suspected to be at high risk W of developing pressure ulcers. The information in the information record may also include information nonspecific to the care recipient but nevertheless imputable to the recipient such as a look-up table that classifies a care recipient's risk of falling as a function of age and medications being administered to the care recipient. Although the look-up table itself is nonspecific to the care recipient, the output from the table is patient specific because the input to the table (e.g. care recipient's age and medications) is specific to the care recipient. Information from a member of the device suite may include whether an adjustable system is ON or OFF, whether it is ON and operating in a specific mode, whether it is ON and operating according to specified operating parameters, and the fraction of specified cycles of a cyclic process that have actually been completed.

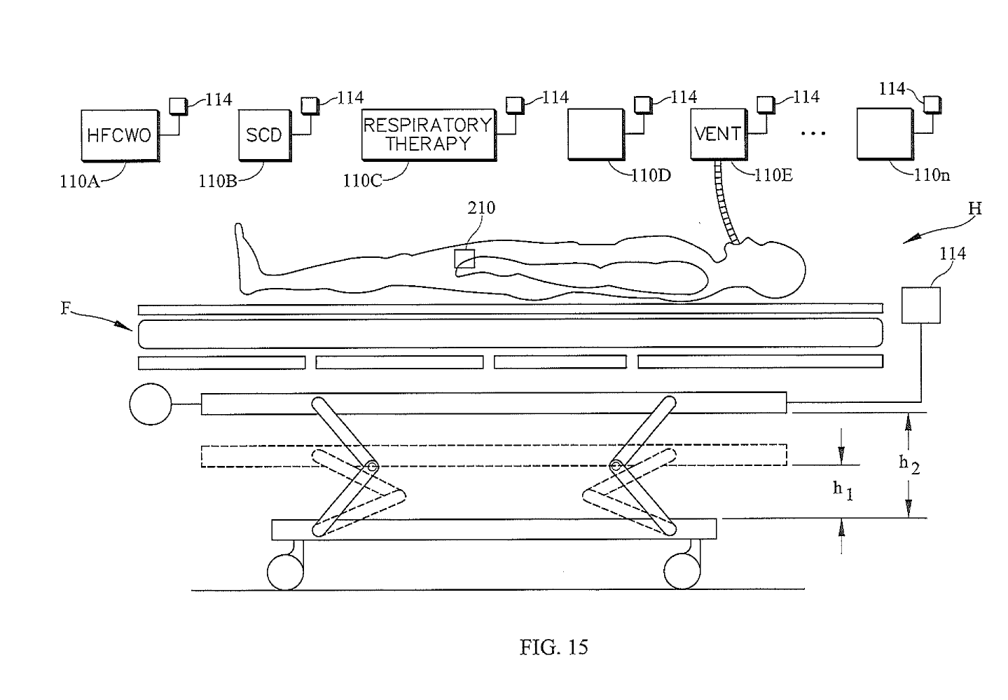

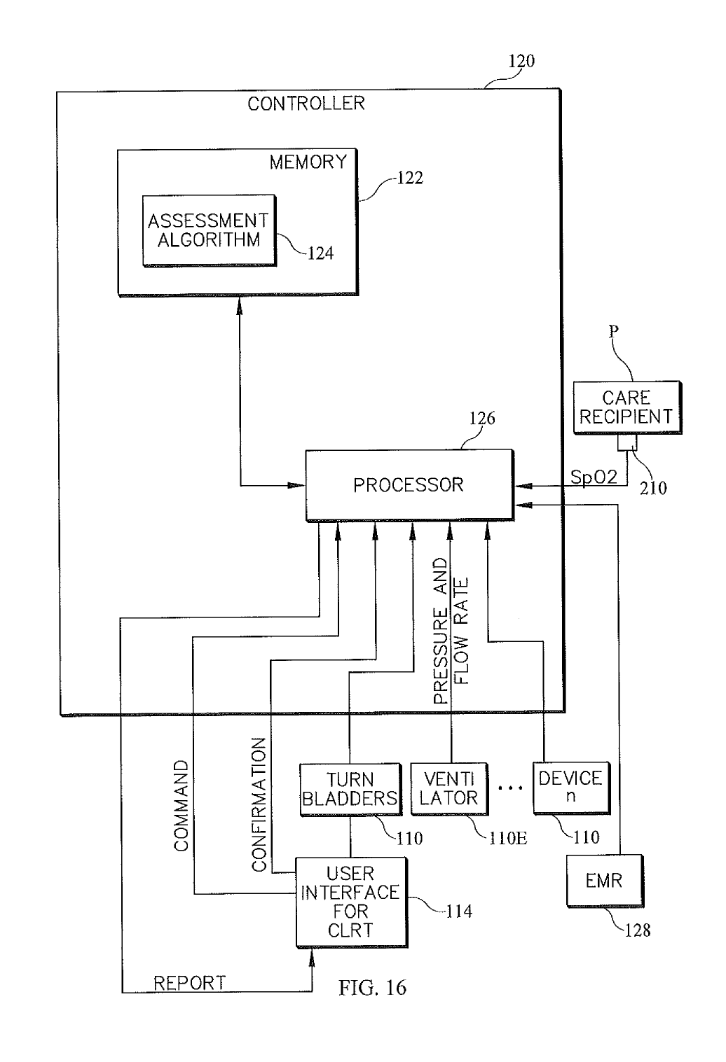

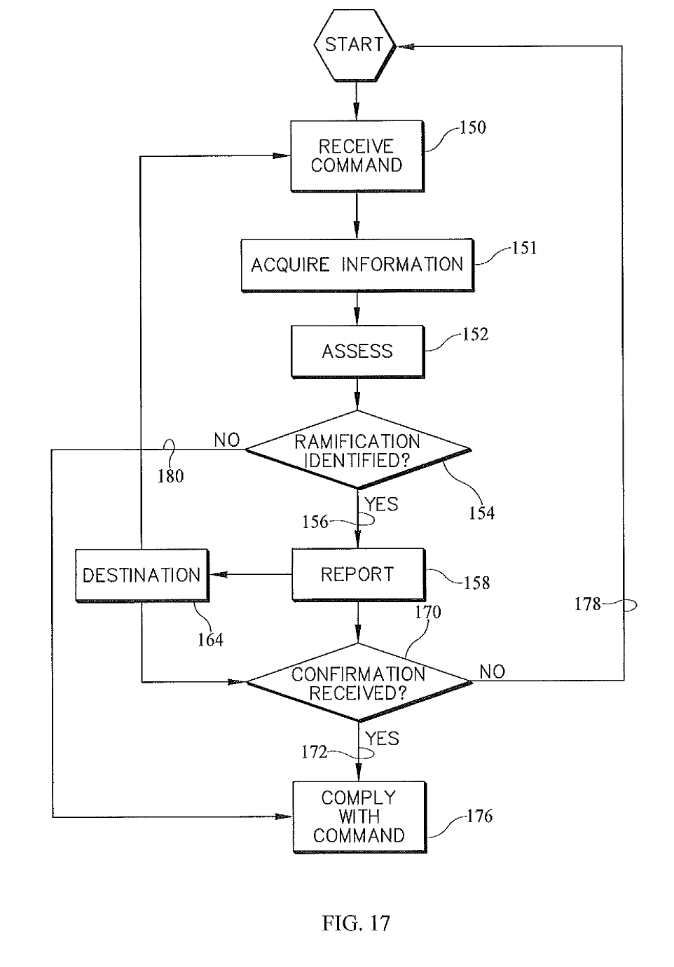

FIGS. 15-18 are similar to FIGS. 1 and 7-9 respectively but present a specific example involving CLRT and also involving information acquisition as in FIG. 14. Some clinicians believe that the maximum inclinaton angle used during CLRT has an effect on the care recipient's blood pressure and peripheral capillary oxygen saturation, SpO2. In particular it is believed that both blood pressure and SpO2 decrease with increasing turn angle σ. In addition, if the care recipient has a poorly functioning lung, some clinicians believe it is inadvisable to orient the care recipent in which her poorly functioning lung would be “down”, i.e. lower in elevation than the better functioning lung.

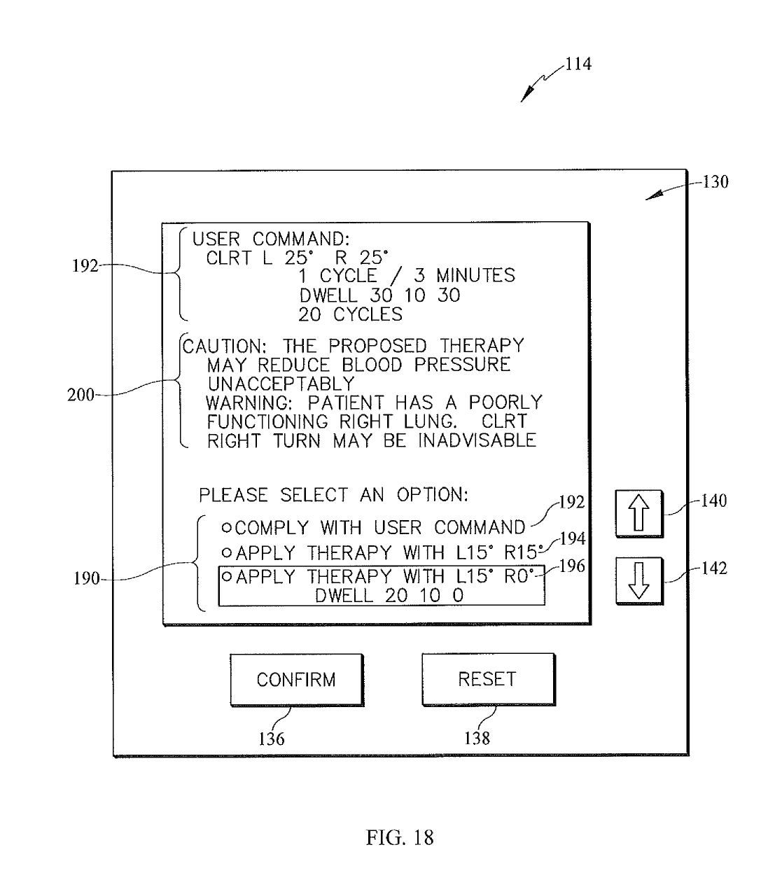

In the example of FIGS. 15-18 a caregiver uses a user interface 114 to set the CLRT parameters, for example a maximum turn angle σ of 25 degrees, a CLRT period T of three minutes (a frequency of one complete CLRT cycle every three minutes), a left turn dwell time d₁ of 30 seconds, a zero turn dwell time d₂ of 10 seconds, a right turn dwell time d₃ of 30 seconds, and a total duration D of 20 CLRT cycles. In this example the algorithm receives SpO2 readings from a monitor 210 attached to the care recipient, receives ventilator pressure and flow rate settings from a ventilator 110E, and receives information from an EMR 128 that the care recipient has pneumonia of the right lung. At block 150 of the method processor 126 receives the caregiver's command to begin CLRT with the caregiver's specified parameters. At block 152 the processor executes algorithm 124 to assess the ramifications, if any, of applying CLRT and of applying CLRT with the specified parameters. At block 158 the method issues a report to a destination, in this case display 130 of FIG. 18. The display shows the original user command 192, possible ramifications 200 of carrying out the command, and a menu 190 allowing the user to select among the original command received at block 150, and two alternatives 194, 196. Alternative command 194 is the application of the CLRT therapy but with a reduced angle of 15 degrees instead of the 25 degrees originally specified. Alternative command 194 falls into the category of an advisory alternative because it does not rely on a patient specific input to the algorithm from the care recipient P, the data repository 128 or one of the devices 40. Instead, it is based on the general, patient nonspecific knowledge that larger turn angles may result in excessively low blood pressure in any patient, not just the specific patient presently being cared for. Alternative command 196 is the application of the CLRT therapy but with left turn only and with that turn limited to 15 degrees and with dwell times of 20 seconds at the left turn limit and 10 seconds at a turn angle of zero. The zero value for the right turn reflects the fact that alternative 196 does not include right turning. Alternative 196 falls into the category of forecastable alternatives because it is based on an undesirable consequence (additional demands on a poorly functioning lung) which is predictable from the patient specific information in the EMR that the care recipient's right lung is unhealthy. In this example the processor has highlighted or otherwise visually distinguished alternative 196 as the default alternative to reveal that alternative 196 is the command recommended by the algorithm. The user may press CONFIRM to confirm acceptance of alternative 196 or may use arrow keys 140, 142 to make a different selection and then press CONFIRM. Assuming that the user presses CONFIRM to accept alternative 196, the method proceeds to block 176 and carries out CLRT as specified in alternative 196. Note that in this example some of the information available to the algorithm, specifically the ventilator parameters and the SpO2 readings, turned out to be not material to predicting the ramification.

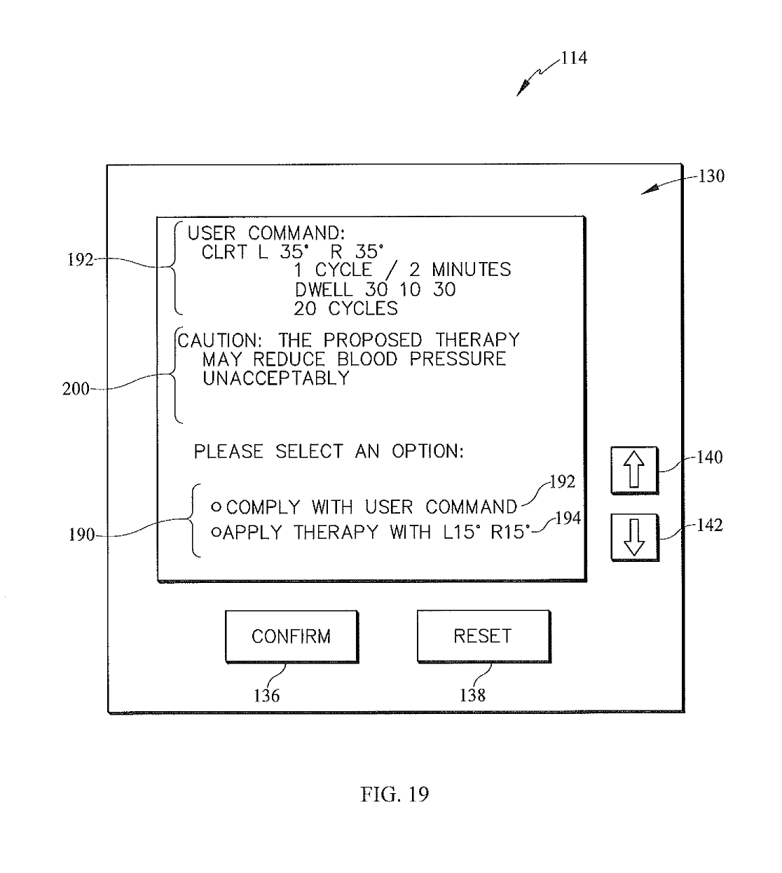

FIGS. 15-17 viewed in conjunction with FIG. 19 show another example in which a caregiver has again used a user interface 114 to specify CLRT and to specify the same CLRT parameters as in the previous example—a maximum turn angle of 25 degrees, a frequency of one complete CLRT cycle every three minutes, a left turn dwell time d₁ of 30 seconds, a zero turn dwell time d₂ of 10 seconds, a right turn dwell time d₃ of 30 seconds, and a CLRT duration D of 20 cycles. However in the present example the EMR does not contain any information that either of the care recipient's lungs is unhealthy. As a result, the only ramification identified by algorithm 124 is the possibility of an adverse affect on the care recipient's blood pressure. Accordingly, The display shows the original user command 192, the ramification 200, and a menu 190 allowing the user to select among the original command received at block 150, and one alternative, namely alternative 194. Alternative command 194 is the application of the CLRT therapy but with a reduced angle of 15 degrees instead of the 25 degrees originally specified. The alternative falls into the category of an advisory alternative because it reflects the general, patient nonspecific knowledge that larger CLRT turn angles may result in excessively low blood pressure rather than relying on a patient specific input to the algorithm by the care recipient.

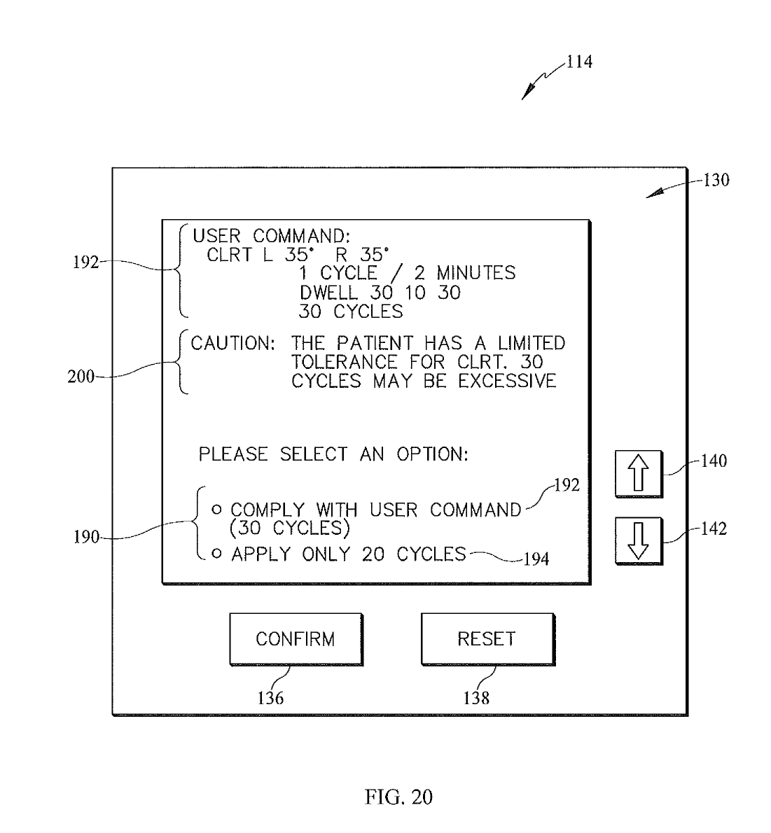

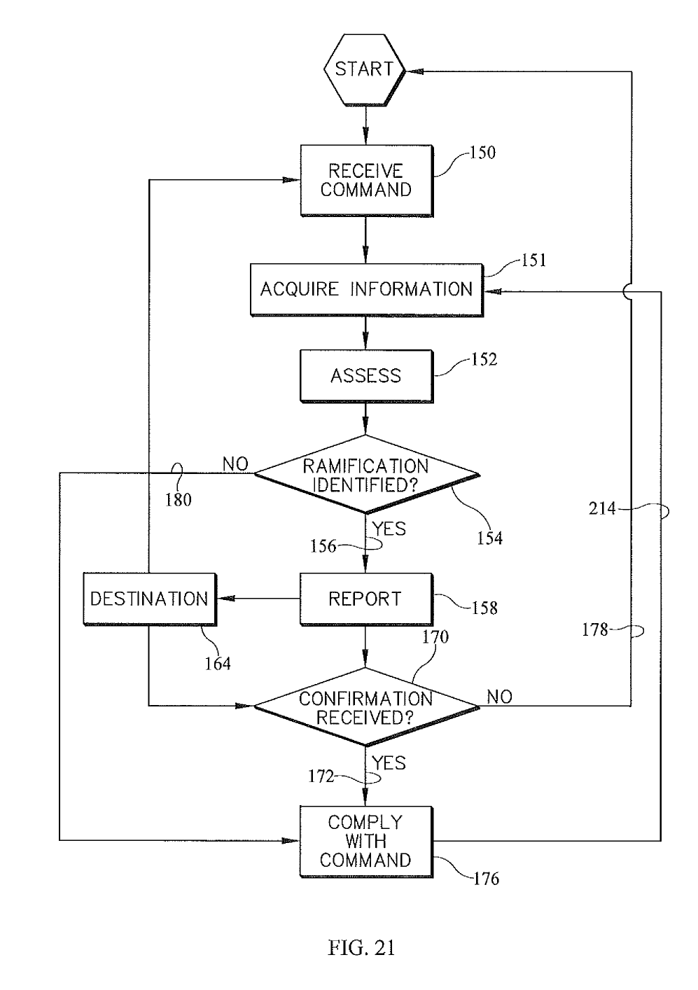

FIGS. 15-17 viewed in conjunction with FIG. 20 show another example. The example can be viewed as one in which a caregiver has used user interface 114 to intervene in an ongoing CLRT therapy by specifying that the therapy should be extended to 30 cycles rather than an initially specified duration of 20 cycles. The example can be alternatively viewed as one in which the caregiver has specified 30 cycles prior to commencement of the process. In this example the EMR includes a profile of the care recipient which reveals that the care recipient has a limited tolerance for CLRT. The algorithm uses the information from the EMR that the care recipient has a limited tolerance for CLRT to determine that 30 CLRT cycles W may be inadvisable. The algorithm causes display area 130 to display a message advising of the care recipient's limited tolerance and suggesting that the user may wish to reconsider the command.

The alternative commands 194, 196 described above are variants of the command received at block 150. However the algorithm can be written to recognize, based on the information available from some combination of the care recipient, the information record, and one or more members of the device suite, that the command received at block 150 is suboptimal or, in the limit, contraindicated. The algorithm may then issue a report in which the alternatives include an action distinctly different from the original command and/or no action at all. If the algorithm recognizes that the command specifies a contraindicated action the method may be set up to disregard the command.

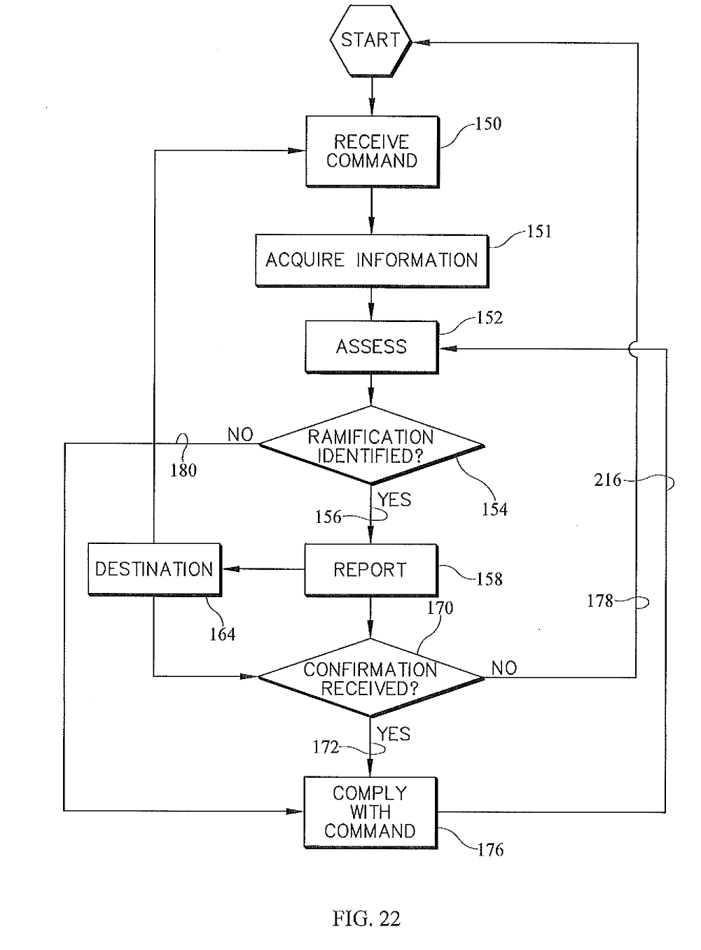

The foregoing examples that involve information acquisition at block 151 are presented as “single assessment” methods which acquire information and make a single assessment based on that information. FIGS. 21-22 show two slightly different enhancements in which the method makes not only an initial assessment analogous to the single assessment mentioned above, but also makes, or is at least configured to make, updated assessments based on newly acquired information. The method of FIG. 21 is the same as that of FIG. 14 except for the addition of branch 214 from block 176. Branch 214 loops back to information acquisition block 151 to indicate that the method continues to access information, either continuously or at intervals, and uses that updated information at block 152 to make an updated assessment. The method of FIG. 22 is the same as that of FIG. 21 except that block 176 branches back to assessment block 152 by way of branch 216 to reflect that the method uses updated information which is already being routinely acquired to make an updated assessment.

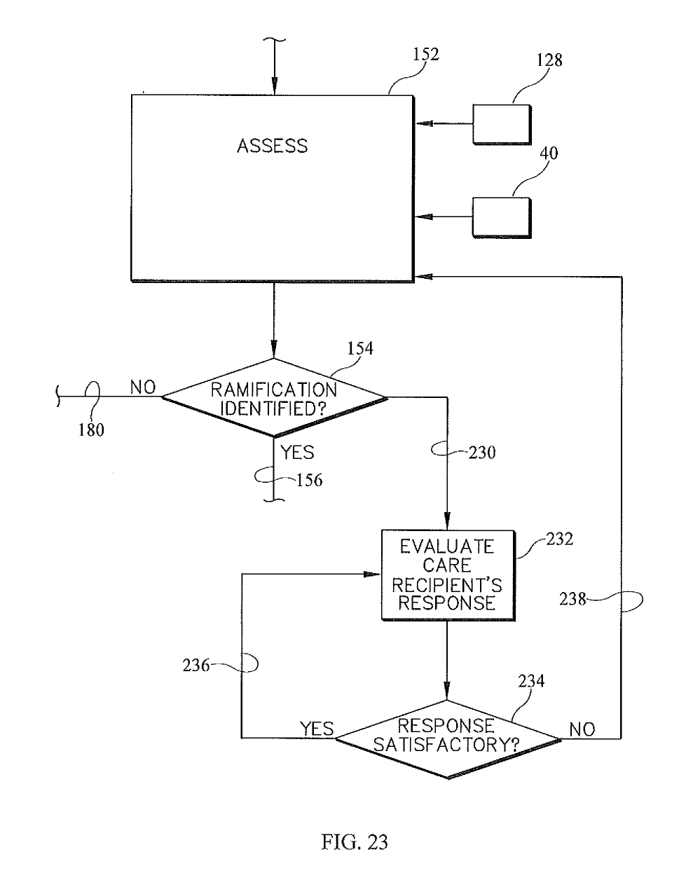

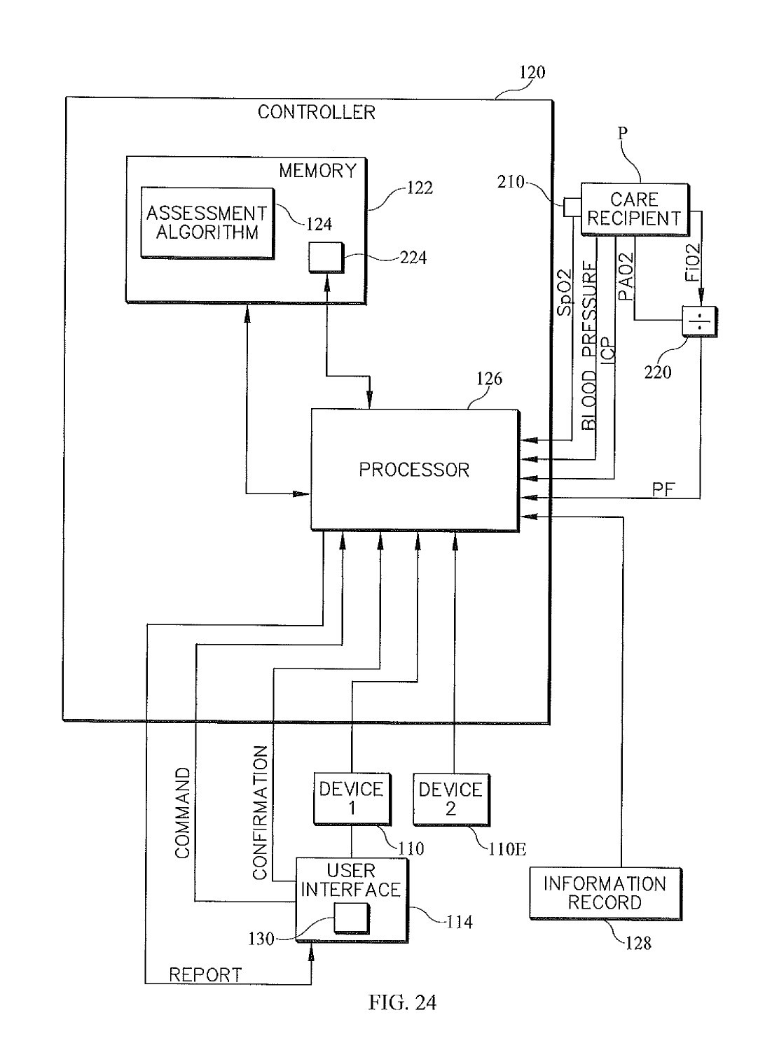

FIG. 23 is a partial block diagram depicting a portion of the block diagram of FIG. 21 or 22. FIG. 24 is an architectural schematic providing an example and a further elaboration of the method of either of FIGS. 21 and 22. At block 152 the method assesses whether or not carrying out a command will result in one or more ramifications. In practice, processor 126 executes algorithm 124 to make the assessment. In the example of FIGS. 23-24 the assessment relies on information from the information repository 128, information from relevant members 40 of the device suite, and information from the care recipient P. The information from the care recipient includes a variety of physiological parameters, namely SpO2, blood pressure, intracranial pressure abbreviated as ICP, PaO2 (the partial pressure of oxygen in the care recipient's arterial blood) and FiO2 (the fraction of oxygen in the gas being breathed by the care recipient). At division box 220 the illustrated method calculates the PaO2/FiO2 ratio (also known as the PF ratio) which is an indicator of hypoxemia. The parameter values and/or the results of any calculations performed with the parameter values may also be periodically stored in memory 122. The enhanced method also receives historical values 224 of care recipient parameters stored in memory 122. Irrespective of whether the method follows branch 156 or branch 180, it also follows branch 230 to block 232 where the algorithm evaluates the care recipient's response to the command. “Response” refers to how the care recipient has or has not been affected by either a change made to an adjustable parameter of an adjustable system or to the absence of such a change. For example the evaluation may take account of how parameters associated with the care recipient, such as his SpO2 reading, respiration rate, blood pressure, or heart rate has been affected by the change or absence of a change. If the care recipient's response is satisfactory the method follows branch 236 from block 234 and continues carrying out evaluations over time at block 232. If the response is unsatisfactory the method follows branch 238 from block 234 and repeats the assessment step by re-executing the algorithm with the information about the care recipient's response. Re-execution of the algorithm results in an updated assessment. The updated assessment may be held in memory until a user uses a user interface 114 to request any updated assessments. Or the updated assessment may be communicated without delay to a destination, such as to a member of the caregiver staff. Similarly, the display at display area 130 can be refreshed on demand or without delay.

Regarding block 232 a care recipient's response is considered satisfactory if his condition improves. The response may also be considered satisfactory if his condition remains stable, particularly if an alternative command (e.g. 194, 196) had been selected due to a perceived risk of carrying out the original command 192. For example if a caregiver selected an alternative maximum CLRT turn angle of 15 degrees instead of an initially commanded value of 25 degrees, and the care recipient's blood pressure was not adversely affected, the care recipient's response may be considered satisfactory. In that case the algorithm may issue a report suggesting that the caregiver consider increasing the maximum turn angle setting. Alternatively the algorithm may implement the increase in turn angle setting autonomously. A care recipient's response is considered unsatisfactory if his condition deteriorates or if his condition remains unimproved despite the application of, for example a therapy such as P&V, which was expected to yield an improvement. In that case the algorithm may issue a report suggesting that the caregiver consider discontinuing the therapy and/or suggesting an alternative therapy. Alternatively the algorithm may act autonomously to discontinue the therapy or substitute a different therapy.

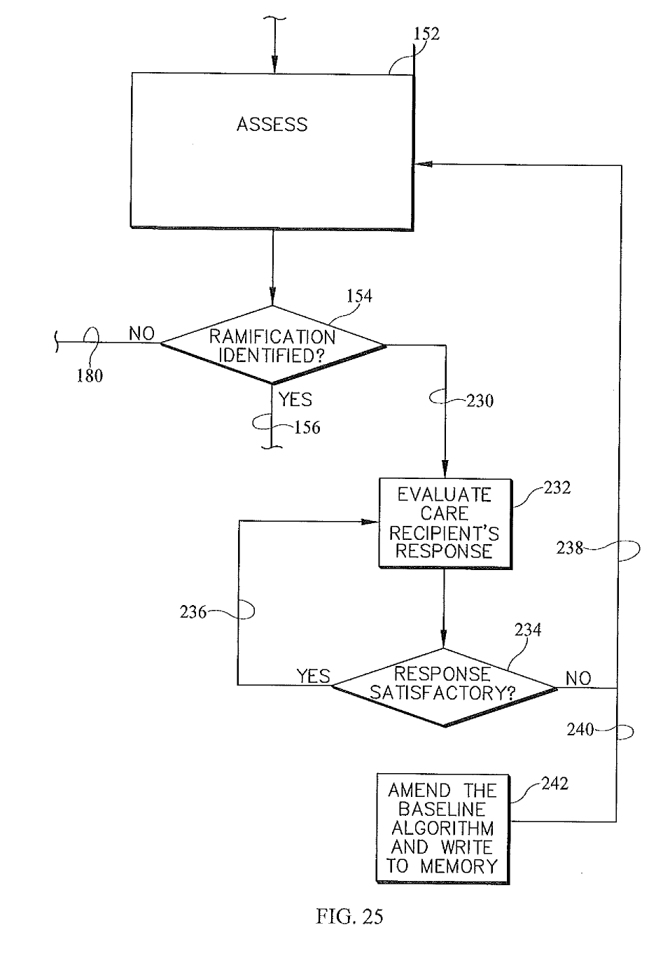

FIG. 25 shows a further enhancement in which an unsatisfactory response at block 234 causes the method to follow not only branch 238 as just described, but also branch 240 to block 242. At block 242 the method uses the evaluation of the care recipient's response to amend the algorithm originally used to carry out the assessment. In one variant of the method the amended algorithm is used in lieu of the original algorithm to carry out future assessments.

Although this disclosure refers to specific embodiments, it will be understood by those skilled in the art that various changes in form and detail may be made without departing from the subject matter set forth in the accompanying claims.

I claim:

1. A method of providing decision support in connection with a care recipient and a suite of care delivery devices, the suite of devices including at least one adjustable system, the method comprising:
receiving a command to effect a change to a parameter of the adjustable system;
assessing whether or not carrying out the command will result in one or more ramifications, the assessing step comprising executing an algorithm; and
if a ramification is identified:
issuing a report related to the identified ramification; and
complying with the command only if a confirmation is received subsequent to the assessing step.

2. The method of claim 1 wherein if a ramification is not identified the method includes complying with the command without further user intervention.

3. The method of claim 1 wherein the confirmation is an explicit confirmation.

4. The method of claim 1 wherein the parameter is a parameter of a repetitive process which process was underway prior to the step of receiving the command.

5. The method of claim 1 wherein:
the step of issuing a report includes suggesting at least one alternative to the command; and
the step of complying includes:
complying with the command if a user selects the command; and
complying with a selected alternative if the user selects from the at least one alternative.

6. The method of claim 5 wherein:
the method preselects one of:
A) the command, and
B) one of the at least one alternatives; and
the step of reporting includes distinguishing the preselected one of the commmand and the at least one alternative from the other or others of the command and the at least one alternative.

7. The method of claim 5 wherein the at least one alternative is based on a forecastable consequence of carrying out the command, the forecastable consequence being based on care recipient specific inputs to the algorithm.

8. The method of claim 1 including:
if the command is complied with, evaluating the care recipient's response to the parameter change; and
A) if the response is satisfactory, continuing to carry out the evaluation of the care recipient's response; and
B) if the response is unsatisfactory repeating the W assessing step with information about the care recipient's response.

9. The method of claim 8 wherein if the response is unsatisfactory, communicating a result of the repeated step of assessing.

10. The method of claim 8 wherein if the result is unsatisfactory, the method amends the algorithm.

11. The method of claim 10 wherein the algorithm is the amended algorithm.

12. The method of claim 1 including:
if the command is not complied with, evaluating the care recipient's response to the noncompliance; and
A) if the response is satisfactory, continuing to carrying out the evaluation of the care recipient's response; and
B) if the response is unsatisfactory repeating the assessing step with information about the care recipient's response.

13. The method of claim 1 wherein the report related to the ramification identifies the ramification.

14. The method of claim 1 comprising the steps of monitoring for a rescission of the command subsequent to the reporting step and, if the rescission is received, declining to comply with the command.

15. The method of claim 1 wherein if the command is W contraindicated the method disregards the command.

16. The method of claim 1 comprising:
collecting information from one or more of:
a) the care recipient,
b) an information record,
c) a member of the device suite, and wherein:
the assessing step uses the collected information to make the assessment.

17. The method of claim 16 wherein the step of collecting information proceeds the assessing step.

18. The method of claim 16 wherein the step of collecting information comprises collecting information from at least one of:
A) sensors associated with the care recipient;
B) an care recipient specific information record,
C) the adjustable system.

19. The method of claim 18 wherein the step of collecting information comprises collecting information representative of at least one of:
A) a care recipient's physiological state;
B) non-physioligical information about the care recipient;
C) the state of the adjustable system

20. The method of claim 1 wherein the device suite includes a bed.

21. The method of claim 1 wherein the adjustable system is a stand alone device or component thereof.

22. A care delivery system comprising suite of care delivery devices each having at least one adjustable system;
a user interface;
a processor configured to receive at least one command from the user interface and to execute an algorithm, the algorithm being adapted to assess whether carrying out the command will result in one or more ramifications; and
a display configured to display a report related to the ramification.

23. The system of claim 22 wherein the suite of care delivery devices includes at least one of:
a bed; and
an information repository.

24. The system of claim 23 wherein the suite of care delivery devices also includes one or more stand alone devices.

25. The system of claim 24 including a sensor for monitoring parameters of a care recipient and an information record, and wherein the processor is configured to receive information from one or more of the sensor, the bed, the stand alone device, and the information repository.

26. A care delivery system comprising:
a bed having at least one adjustable system;
a user interface configured to receive a command from a user to adjust a setting of the adjustable system and to provide information to the user; and
a processor electronically coupled to the at least one adjustable system and to the user interface, the processor configured to:
receive the command and assess whether or not carrying out the command will result in one or more ramifications; and
if the processor identifies a ramification, to issue a report of the ramification by way of the user interface.

27. The care delivery system of claim 26, wherein the processor is configured to await a confirmation that the user wishes to proceed with the command and to prevent compliance with the command unless the confirmation is received.

28. The care delivery system of claim 26, wherein the processor is configured to await an instruction that the user wishes to cancel the command and to comply with the command if the instruction is not received within a predetermined period of time.

29. The care delivery system of claim 26 further comprising a memory coupled to the processor, the memory storing an electronic medical record including information, the W processor being configured to receive the information and use the information to assess whether or not carrying out the command will result in one or more ramifications.

30. The care delivery system of claim 26 further comprising a physiological sensor coupled to the processor, the processor being configured to receive information from the physiological sensor and use the information to assess whether or not carrying out the command will result in one or more ramifications.

31. The care delivery system of claim 26 wherein the processor is configured to receive information from the at least one adjustable system and use the information to assess whether or not carrying out the command will result in one or more ramifications.

32. The care delivery system of claim 29 further comprising a physiological sensor coupled to the processor, the processor being configured to receive information from the physiological sensor and from the at least one adjustable system, use the information from the physiological sensor and the at least one adjustable system to assess whether or not carrying out the command will result in one or more ramifications.

33. The care delivery system of claim 32 wherein the at least one adjustable system is a hospital bed.
